(19) United States
(12) Patent Application Publication
(10) Pub. No.: US 2010/0164182 A1
(43) Pub. Date: Jul. 1, 2010

(54) MULTI-PART OIL SCRAPER RING FOR INTERNAL COMBUSTION ENGINES

(76) Inventors: Michael Hummel, Stuttgart (DE); Alexandros Mizoglou, Stuttgart (DE)

Correspondence Address: COLLARD & ROE, P.C., 1077 NORTHERN BOULEVARD, ROSLYN, NY, 11576, US

(21) Appl. No.: 11/990,048

(22) PCT Filed: Jul. 18, 2006
(86) PCT No.: PCT/DE2006/001238

§ 371 Date: Jul. 2, 2008

(30) Foreign Application Priority Data
Aug. 6, 2005 (DE) 10 2005 037 203.1

(51) Int. Cl. F16J 9/06

(52) U.S. Cl. 277/481

(57) ABSTRACT

In the case of a multi-part oil scraper ring (10) for internal combustion engines, having a U-shaped expanding-spring ring (1), which is provided with axial indentations (2), for forming radially outwardly aligned resilient limbs (3, 4) which are connected to one another by means of radially inwardly situated webs (5), and having at least two annular lamellae (7, 8) which are provided with in each case parallel flanks (7a, 7b; 8a, 8b) and are stacked via their flanks as stacking planes (SE) to a height (h_{L}) and are arranged between the resilient limbs of the expanding-spring ring in order to define a nominal height of the oil scraper ring, according to the invention, an at least three-part oil scraper ring of a minimum axial installation height and with an improved oil-scraping effect should be obtained in that at least in each case one of the flanks (7a, 7b; 8a, 8b) of the lamellae has, in its radially inwardly situated wall region, a cut-out (11) which has a support face (12) for the engagement of the resilient limbs (3, 4) of the expanding-spring ring and is shaped such that the nominal height of the oil scraper ring is determined exclusively by the stack height (h_{L}) of the lamellae (7, 8).

The invention relates to a multi-part oil wiping ring for internal combustion engines, having a U-shaped spreader spring ring provided with axial incisions, for forming resilient shanks directed radially outward, and having at least two ring-shaped lamellae provided with parallel flanks, in each instance, which are stacked to a height by way of one of their flanks as the stack plane, and are disposed between the resilient shanks of the spreader spring ring, in order to define a construction height of the oil wiping ring.

A two-part oil wiping ring having a spreader spring ring configured in U shape is known from DE 197 04 754 C1. A single lamella that is disposed between the shanks of the spreader spring ring permits a construction height of the oil wiping ring of approximately 1.5 mm. As compared with other known two-part oil wiping rings, for example those known from DE 27 11 018 C2, this solution possesses the advantage that a tangential force that is still sufficient is exerted on the lamella by the spreader spring, so that the oil wiping effect can also be considered to still be sufficient. A reduction in the construction height to as low as or below 1.5 mm thereby leads to an insufficient wiping effect, as is also described in DE 197 94 754 C2, so that construction heights on this order of magnitude therefore no longer appear to be possible to implement for three-part rings.

It is the task of the present invention to indicate an at least three-part oil wiping ring having a minimal axial construction height, that permits a significantly improved oil wiping effect as compared with known oil wiping rings.

According to the invention, this task is accomplished by means of the characteristics of claim 1.

By means of the proposed design of the three-part oil wiping ring, which consists of a U-shaped spreader spring ring having lamellae disposed between its shanks, on the one hand, a construction height is achieved, in advantageous manner, that corresponds to that of a two-part oil wiping ring, for example the one according to DE 197 04 754 C1. On the other hand, a tangential force is exerted on the lamellae by means of the spreader spring ring that is used, which force is further increased in that a specific configuration of the contact surface for the spreader spring shanks is provided, so that an additional tangential force component on the ring lamellae is produced, which leads to an improved oil wiping effect. In addition, the configuration of the contact surface permits significantly simplified assembly of the lamellae.

Advantageous further developments are the subject of the dependent claims.

The invention will be explained in greater detail in the following, using an exemplary embodiment. The figures show:

FIG. 1 a perspective view of the oil wiping ring according to the invention;

FIG. 2 a perspective sectional representation of the oil wiping ring in a first embodiment;

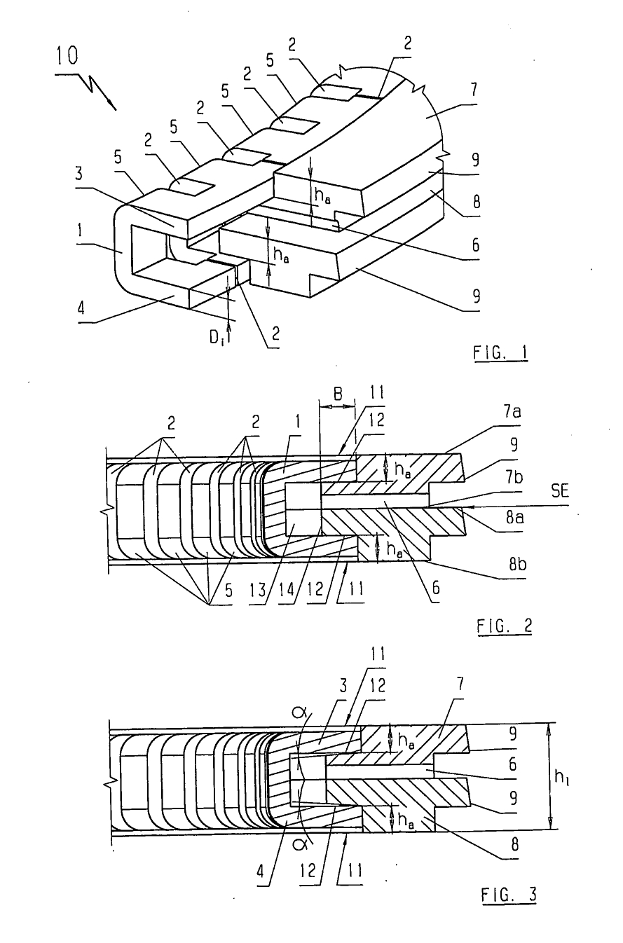

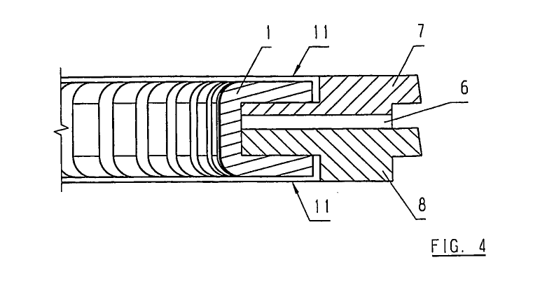

FIG. 3 a perspective sectional representation of the oil wiping ring in a second embodiment;

FIG. 4 a perspective sectional representation of the oil wiping ring in a third embodiment.

In the perspective view according to FIG. 1, an oil wiping ring according to the invention is formed from a spreader spring ring 1 having a U-shaped cross-section, between whose shanks 3 and 4, which are radially directed outward, ring-shaped lamellae 7 and 8 that are stacked on top of one another, having a running surface 9 are disposed. The spreader spring ring 1 has slits 2 on its radially inner side, so that the shanks 3 and 4 are connected with one another by way of crosspieces 5 that are configured as spring ring backs. The spreader spring ring 1 is structured to be resilient in the circumference direction, by means of the slits 2.

The lamellae 7 and 8, which consist of steel or cast iron, and can be structured as Napier rings, have flanks 7a, 7b and 8a, 8b that are oriented parallel to one another, in each instance, whereby the lower flank 7b of the upper lamella 7 and the upper flank 8a of the lower lamella 8 serve as stack planes SE. The flanks in the stack plane SE possess a roughness of Rz<2 μm for steel lamellae and Rz<4 μm for cast lamellae. According to FIGS. 2 and 3, the lamellae have a recess 11 directed axially upward for the upper lamella 7, and a recess directed downward, for the lower lamella 8, each having a contact surface 12, in which the shanks 3 and 4 support themselves in resilient manner, at their radially inner ends, in other words in the direction of the back of the spreader spring ring 1. According to a first exemplary embodiment, the contact surface 12 is oriented parallel to the flanks 7a, 7b and 8a, 8b, whereby according to a second exemplary embodiment according to FIG. 3, the contact surface 12 runs at an incline angle α between 2° to 20° towards the stack plane. As a result, simple assembly of the lamellae is made possible, on the one hand, and on the other hand, an at least partial additional force component that acts radially on the lamellae is created, for a better oil wiping effect.

The recesses 12 in the lamellae are structured with mirror symmetry relative to one another, with the stack plane SE as the mirror plane, and have a height hₐ that is greater than the thickness Dᵢ of a shank of the spreader spring ring 1, in each instance. In this way, in contrast to the existing state of the art, a construction height—nominal height—of the oil wiping ring 10 is implemented that is exclusively determined by means of the height h_{L}, of the lamellae 7 and 8 that are stacked on top of one another. The support of the shanks 3 and 4 of the spreader spring ring 1 takes place in a radial width B of the contact surface 12, which corresponds to approximately one-third of the radial total width of the lamellae, so that sufficient guidance is guaranteed. Oil grooves 6 that run radially are worked in on the lower flank 7a of the upper lamella 7, on the circumference side, at an angle distance of 20°, in other words a total number of 18 pieces, by means of which oil to be wiped off the cylinder wall is transported to the side of the spreader spring ring that lies radially on the inside, into the oil chamber 13, by means of the lamella 7, and transported away to the engine space on the crankshaft side, by means of the incisions 2.

According to a third exemplary embodiment of the oil wiping ring 10 according to the invention, according to FIG. 4, the recesses 11 of the two lamellae 7 and 8 are structured in such a manner that the side 14 of the lamellae 7 and 8 that faces away from the running surfaces 9 lie against the back of the spreader spring ring 1, thereby making it possible to increase the radial width B of the contact surface 12. In this connection, the oil to be wiped off the cylinder wall is directly transported away to the engine space on the crankshaft side by way of the incisions 6, by means of the oil grooves 6 that run radially.

The lamellae 7 and 8 can usually be treated to form a nitride layer, by means of a gas nitration process (GNS). Likewise, a friction-wear coating of the running surfaces 9 can be applied by means of a PVD method, for example a CrN coating.

The oil wiping ring 10 is inserted in the oil ring groove of a piston with sufficient play, in the installed state. In this connection, the spreader spring ring 1 is tightened to a smaller diameter, in that it is compressed in the circumference direction, so that the radial spring force that results press the lamellae 7 and 8 against the cylinder wall, whereby a particularly slight axial construction height for a three-part oil wiping ring is implemented, by means of the special configuration of the recess 11 for accommodating the shanks 3, 4 of the spreader spring ring 1.

### Reference Symbols

10 multi-part oil wiping ring
1 spreader spring ring
2 axial incisions
3, 4 shanks of the spreader spring ring
5 crosspieces
6 oil groove
7 upper lamella, side facing the combustion chamber of the engine
7a lamella flank, axial top
7b lamella flank, axial bottom
8 lower lamella, side facing away from the combustion chamber of the engine
8a lamella flank, axial top
8b lamella flank, axial bottom
9 running surfaces
11 recess
12 contact surface
13 oil chamber
α angle of incline of the contact surface
B radial width of the contact surface
Di shank thickness
h_{L} stack height of the lamellae
h_{A} axial height of the recess
SE stack plane

1-8. (canceled)

9. Multi-part oil wiping ring (10) for internal combustion engines, having a U-shaped spreader spring ring (1) provided with axial incisions (2), for forming resilient shanks (3, 4) directed radially outward, and having ring-shaped lamellae (7, 8) provided with at least two parallel flanks (7a, 7b; 8a, 8b), in each instance, which are stacked to a height (h_{L}) by way of one of their flanks as the stack plane (SE), and disposed between the resilient shanks of the spreader spring ring, in order to define a nominal height of the oil wiping ring, whereby at least one of the flanks (7a, 7b; 8a, 8b) of the lamellae, in each instance, have a recess (11) in their wall region that lies radially inward, with a contact surface (12) for engagement of the resilient shanks (3, 4) of the spreader spring ring, in its wall region that lies radially on the inside, shaped in such a manner, and whereby the nominal height of the oil wiping ring is exclusively determined by the height (h_{L}) of the lamellae (7, 8), wherein the contact surface (12) of the recess is structured to be inclined radially inward towards the stack plane (SE), in its axial height (hₐ).

10. Multi-part oil wiping ring (10) according to claim 9, characterized in that the angle of incline (α) amounts to between 2′ and 20′.

11. Multi-part oil wiping ring (10) according to claim 9, characterized in that at least one of the flanks (7b, 8b) of the lamellae (7, 8) disposed in the stack plane (SE) have grooves for the oil to run off, distributed over the circumference, over their entire radial wall thickness.

12. Multi-part oil wiping ring (10) according to claim 9, characterized in that the lamellae (7, 8) consist of steel or cast iron.
